(19) United States
(12) Patent Application Publication
(10) Pub. No.: US 2010/0009246 A1
(43) Pub. Date: Jan. 14, 2010

(54) Bypass Function for a High Voltage Battery Cooling Strategy

(75) Inventors: Jerome MAITRE, Royal Oak, MI (US); Ralph Ostermeier, Munich (DE); Christoph Niedermeier, Munich (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/170,178

(22) Filed: Jul. 9, 2008

(51) Int. Cl. H01M 10/50; F28D 15/00

(52) U.S. Cl. 429/62; 429/120; 165/104.31; 165/104.33

(57) ABSTRACT

A cooling system and method for a vehicle battery is described. A high flow rate cooling loop in heat transfer communication with the battery is provided, for removing heat from the battery with a coolant. A first cooling device may be selectively coupled to the high flow rate cooling loop, using a refrigerant fluid to transfer heat with the coolant, and a second cooling device can also be selectively coupled to the high flow rate cooling loop, using ambient air to transfer heat with the coolant. A valve for directing the coolant to at least a selected one of the first and second cooling devices is provided, and a controller is used to implement a coolant flow bypass function by commanding operation of the valve to bypass the selected one of the cooling devices to limit a temperature gradient between the coolant and the battery.

### BACKGROUND AND SUMMARY OF THE INVENTION

Hybrid vehicles use electric motors alimented by one or more batteries to supplement the propulsion provided by a main motor, such as an internal combustion engine. All electric vehicles also require high performance batteries. High performance batteries, however, generate a large amount of heat as a byproduct of the generation of electricity. The heat has to be removed, to retain the performance of the battery and to prevent damage due to overheating, and also to prevent a possible fire hazard to the vehicle.

It is also important when using high performance, high voltage (HV) batteries to maintain a uniform temperature of the battery. The batteries are typically formed by packs of multiple cells, tied together physically and electrically to provide a compact and powerful source of electricity. Under certain circumstances, some of the cells may produce more heat than their neighboring cells, so that the cooling scheme used for the battery has to homogenize the temperature profile for all the cells in the battery. In other cases, the environment of some of the cells results in more heating and/or less cooling.

Current batteries used in many conventional and hybrid vehicles are of the nickel-metal hydride (NiMH) type, which provides a good amount of stored power for the size and weight of the battery. These batteries also generate enough heat that a cooling scheme is necessary to maintain them at an acceptable operating temperature while being used in different environmental conditions, and being subjected to various demands. Other types of batteries, however, may also be used. For example, a promising new type of battery for hybrid power plants is the lithium ion battery, which provides more power for a given size and weight of the battery. Other battery technologies also have been or are in the process of being developed because of the great interest in vehicles due to environmental and fuel cost concerns. These batteries with higher power concentration, or other electricity storage and/or production components, may require even more cooling to maintain a uniform operating temperature, and to prevent unsafe conditions.

The exemplary embodiments of the present invention provide a cooling scheme or strategy which ensures that the heat generated by the battery during its operation is removed. The battery's cells remain at a constant and uniform temperature, close to an ideal temperature for the efficient operation of the battery, and which prevents dangerous overheating conditions of the battery that can lead to fire and other damage.

The high voltage battery according to exemplary embodiments of the invention is cooled with a coolant flowing at a high flow rate, to ensure a homogeneous cooling of all the cells in the battery pack. The high flow rate promotes a homogeneous temperature profile for the cells.

The heat transfer from the battery, thus the cooling of the battery cells, is a function of the temperature gradient between the battery cells and the coolant. A maximum temperature gradient for a give system is selected, which results in a limit to the maximum cooling of the battery cells. This precaution avoids thermal shocks and the resulting high stresses that can damage or destroy the battery if it is cooled too fast.

According to one exemplary embodiment of the invention, a battery cooling loop is provided to cool the battery cells with a liquid coolant. For example, the coolant may be a glycol-based coolant similar to the coolant used in the vehicle's engine cooling system. Other suitable cooling fluids may be used for this function, as would be understood by one of skill in the art. Preferably, the cooling loop for the battery cells is separate from the cooling system of the vehicle's engine (i.e. the internal combustion engine). However, in other exemplary embodiments, the same coolant may be circulated for cooling both the engine and the battery.

The coolant in the battery loop may in turn be cooled by being directed into one or more additional loops, each loop containing different cooling devices. For example, a first cooling device such as a refrigerant/coolant heat exchanger (also referred to as a chiller) may be used to control the temperature of the coolant in the battery's high flow rate cooling loop. In one example, R134 refrigerant may be used through the chiller to cool the coolant.

A second cooling loop may be provided, for example containing a second cooling device such as an air/coolant heat exchanger (HE) which uses ambient air to control the coolant temperature of the battery's high flow rate cooling loop. The HE may be placed in such a position that outside ambient air is forced through the HE when the vehicle moves.

In an embodiment according to the invention, both of the loops may be used to remove heat from the battery coolant loop. A valve or other selector device may be used to determine whether the two loops are operated separately or simultaneously. For example, a duo-valve may be used to direct the coolant flow from the battery coolant loop to transfer heat using the chiller loop, the HE loop, or a combination of the two. The duo-valve may include a simple on-off valve, or may have a proportional valve, allowing a graduated division, or bypass, of the coolant between the two cooling loops.

A problem occurs when it is necessary to change the amount of heat transferred from the batteries of the hybrid vehicle. The flow rate of the coolant flowing in the battery cooling loop typically cannot be changed, because a high flow rate is necessary to maintain a homogeneous temperature of all the battery cells. The inability to change the battery coolant loop's flow rate may result, under certain circumstances, in a high temperature gradient between the battery and the coolant, which can result in damage to the device.

In addition, other difficulties exist in regulating the cooling rate of the battery. To simplify the design and construction of the cooling system, the chiller disposed in the refrigerant loop may be connected to the air conditioning system which provides cooling to the passenger cabin. The exemplary chiller thus operates in parallel or in series with the vehicle AC system, using the same working fluid. Conventionally, the cooling capacity of the refrigerant coolant loop is controlled by regulating the refrigerant flow rate, using a thermostatic valve and/or with an on/off valve. However, changing the flow rate of the refrigerant results in a degradation of the performance of the AC system, which is felt by the passengers as uncommanded temperature variations. The durability of the valves also suffers from the additional use to control battery cooling. Neither of these effects are acceptable when designing the battery cooling system.

The cooling capacity of the HE cooling loop is greatly influenced by the amount and temperature of the outside air passing through the heat exchanger, since the HE is generally positioned on the vehicle so that ambient air flows over it when moving. Thus, lower ambient temperatures and higher speeds of the vehicle result in a much enhanced ability of the HE to cool the battery coolant. These parameters are outside of the control of the battery cooling system, and thus not only can't be used to optimize the battery cooling, but may interfere with what the control system is attempting to achieve, for example by cooling the battery too fast.

According to the embodiments of the present invention, a control system is used to affect the battery cooling using logic that varies the bypass, which is the division of how much coolant fluid is directed to the chiller using the refrigerant cooling loop, and how much is directed to the HE using the outside air for cooling. According to the invention, one of the cooling devices is used as a primary cooling device for the coolant, and the other forms a bypass loop, which is more or less used depending on the system's conditions. This arrangement prevents over cooling of the batteries which can result from too high a temperature gradient between the coolant in the high flow rate cooling loop and the battery cells. It also prevents negatively affecting passenger comfort by impairing the operation of the air conditioning system, and reducing the life of conventional air conditioning components.

The operation of an exemplary embodiment of the invention is more clearly illustrated using two examples. In a first example, low exterior air temperature is present. The exemplary exterior ambient temperature is −25° C. and the battery is at a temperature requiring it to be cooled. Initially the battery is cooled by the HE coolant loop, since the ambient temperature is low, and all of the coolant flows over the HE which is cooled by ambient air. The chiller of the refrigerant loop is deactivated, so that there is no refrigerant flowing therethrough. Under these conditions, the HE loop with ambient air cooling is primary, and the deactivated chiller loop is used as a bypass. A coolant pump is kept on in all cases, to maintain the necessary high coolant flow rate over the battery cells.

Because of the low ambient temperature, the cooling rate over the HE is very strong, and the coolant temperature rapidly drops to a low value, at which point the temperature delta between the coolant and the battery reaches a predetermined gradient limit. This gradient limit may be selected as the maximum allowable temperature gradient, activating the bypass function according to the invention to prevent the temperature gradient from further increasing. The bypass function logic causes opening of the duo-valve allowing the coolant to flow over both the primary HE loop and the bypass chiller loop. Because the chiller is deactivated, the refrigerant therein is not producing a cooling effect. By bypassing some of the coolant to the deactivated chiller loop, the maximum allowable gradient delta temperature is not exceeded.

In a second example, the exterior ambient temperature is high, for example 15° C. The battery temperature starts at a temperature necessitating cooling. In this case, the chiller is activated, and the coolant pump is on. The chiller loop with the flowing refrigerant is primary in this case, and the HE loop is used as a bypass. After some time in operation, the chiller reduces the coolant temperature to a low value, so that the temperature delta between coolant and battery cells reaches the maximum allowable temperature gradient limit. To prevent excessive cooling, the bypass function is activated, and opens the duo-valve so that the coolant flows both in the primary chiller loop and the bypass HE loop.

In both examples of the system's operation the duo valve can be controlled by an electronic control unit which monitors temperatures and/or bypass flow rate in the system to maintain the desired temperature gradient. Those of skill in the art will understand that other types of control mechanisms may be used. For example, mechanical rather than electronic controls may be used, and simpler, less expensive devices such as thermostatically actuated valves may be used to obtain some of the benefits of the invention.

As indicated above, the bypass may simply include switching from one cooling loop to the other, and back as necessary, with substantially all of the coolant flowing in one of the loops at a time, as directed by the control unit. Alternatively, a selected fraction of the coolant may flow in one of the loops, and the remainder in the other loop at the same time, to control the coolant temperature and maintain the temperature gradient within desired limits. If bypassing only a portion of the coolant flow is not sufficient to control the temperature gradient, the entire coolant flow can be bypassed to the other loop.

Other objects, advantages and novel features of the present invention will become apparent from the following detailed description of the invention when considered in conjunction with the accompanying drawings.

### BRIEF DESCRIPTION OF THE DRAWINGS

The present invention is described in the following with reference to the drawings listed below. In the drawings:

FIG. 1 is a schematic diagram showing an exemplary embodiment of the battery cooling system according to the invention; and

FIG. 2 is a flowchart showing an exemplary operation of the battery cooling system according to the invention.

### DETAILED DESCRIPTION OF THE DRAWINGS

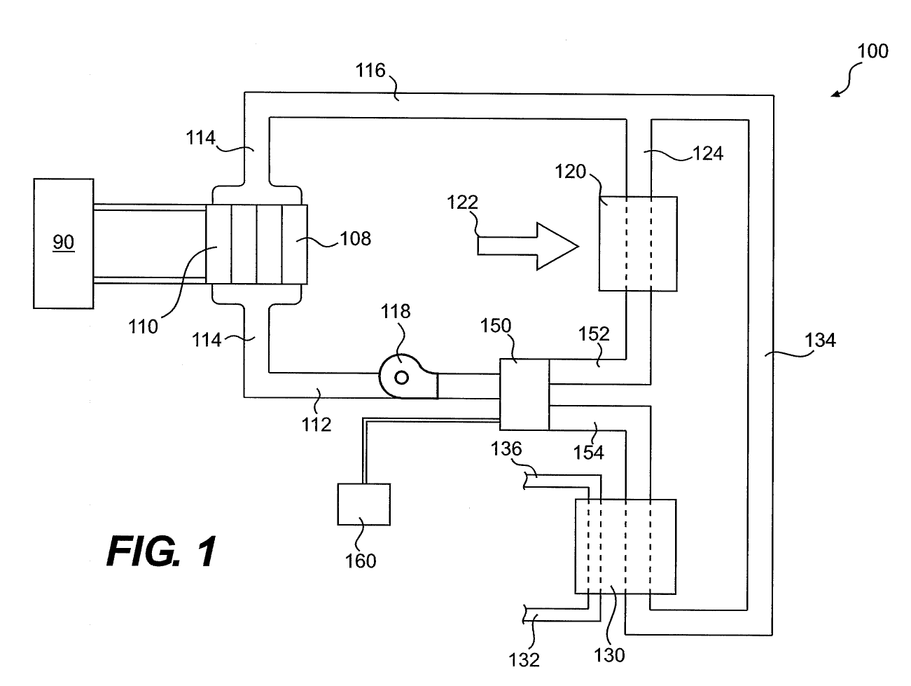

An exemplary embodiment of a battery cooling system according to the invention is shown in FIG. 1. In this embodiment, a battery 110 includes multiple cells 108 that are cooled using a cooling system 100. The battery 110 may be, for example, part of a hybrid power plant system 90 of a vehicle, and may be operatively connected to provide and store electrical energy as needed. Those of skill in the art will understand that instead or in addition to a battery 110, other elements adapted for storing and/or generating electricity and which require cooling may be used according to the invention. These may include, for example, capacitors, fuel cells, etc.

A coolant 114 is used to cool the cells 108 of the battery 110. Coolant 114 is circulated, for example, by a pump 118. In an exemplary embodiment, the coolant 114 may be automotive coolant, such as a glycol based fluid. As described above, the flow rate of the coolant is kept constant at a high value, to ensure a uniform and homogeneous temperature of the battery cells 108.

The cooling efficiency of the system depends on the coolant flow rate and the temperature gradient between the battery cells 108 and the coolant 114. The greater the gradient, the greater the heat transfer. However, an excessive temperature gradient may cool the battery too fast, and may cause damage or failure of the battery 110. To prevent such damage the system according to the invention operates to maintain a temperature gradient between the cells and the coolant which does not damage the cells, and which may vary, among others, depending on the type of cells and of coolant used.

To achieve this performance, the present exemplary system uses a duo-valve 150 connected to the outlet conduit 112, which is controllable to direct the flow of coolant 114 towards the ambient air heat exchanger HE 120, towards the refrigerant-cooled chiller 130, or both. The duo-valve 150 may be operated by an electronic controller 160, or other system able to respond, for example, to temperatures in the environment and in the cooling system 100.

A conduit 152 connects the duo-valve 150 to the HE 120, in which heat is removed from the coolant 114 by passing a flow of ambient air 122 therethrough. The cooled fluid is then returned to the battery 110 via return lines 124, 116. The HE 120 is preferably mounted on a location on the vehicle where it is exposed to the stream of air caused by movement of the vehicle. Its efficiency is thus greatly affected by the ambient temperature and the speed of the vehicle.

In one exemplary embodiment, the duo-valve 150 includes two solenoids, each controlling a valve, that regulate the coolant flow towards either the chiller loop or the HE loop. The solenoids may be under control of the control unit 160, which executes logical instructions to carry out the bypass function in response to temperatures sensed in the battery and the ambient air. The speed of the vehicle may be an additional input parameter for the control unit 160. However, as described above, the operation of the duo-valve 150 to carry out the bypass function may be simplified, and may be based on temperature activated valves, without the need for an electronic control unit.

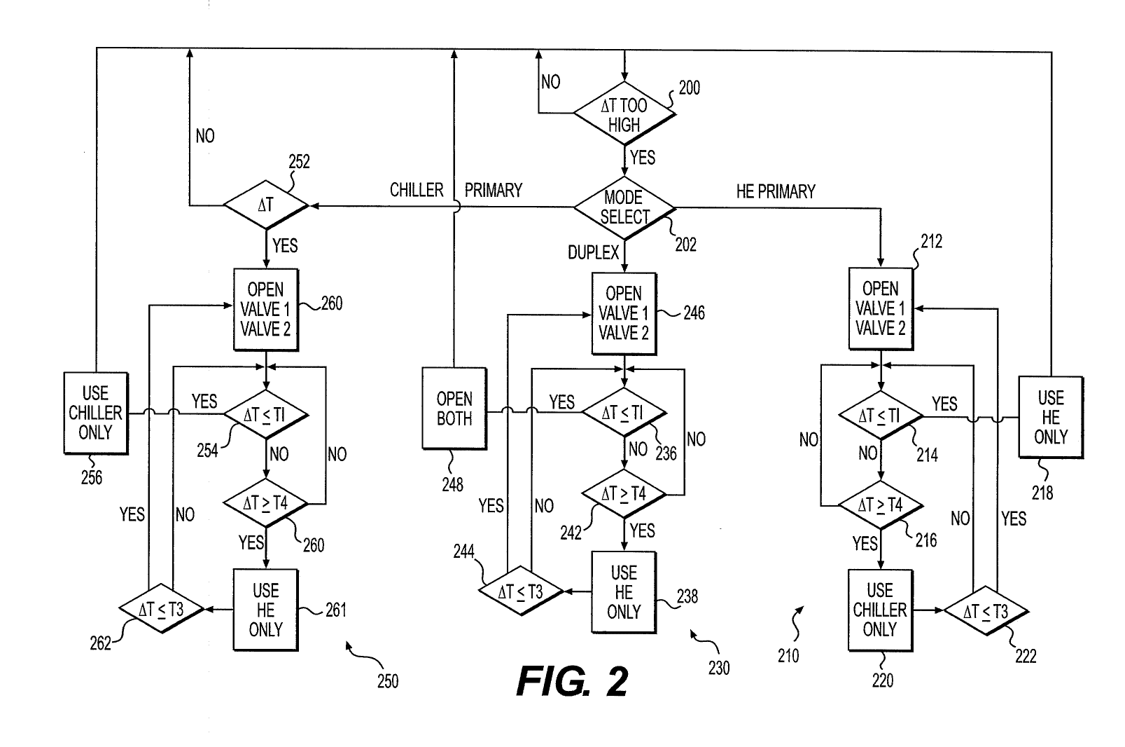

According to the exemplary embodiments of the invention, the amount of cooling applied to the coolant loop going to the battery, and thus the temperature gradient applied to the battery cells, may be controlled by the bypass function, which directs the flow of coolant to one or both the HE loop and the chiller loop. The bypass is selected by evaluating, for example, the sensed temperatures of the ambient air, the battery and the coolant in contact with the battery. Additional parameters may be also considered in more complex embodiments of the bypass function. FIG. 2 shows an exemplary flow chart of the operation of the bypass function according to the invention.

The bypass function operates by initially determining in step 200 whether the temperature gradient, i.e. the temperature difference (ΔT) between the battery cells and the coolant is too high. If the ΔT is greater than a defined threshold value, the operating mode of the bypass function is selected in step 202 to optimize the cooling of the battery. The exemplary choices for the operating mode include primary HE loop, primary chiller loop, and duplex operation including both loops. The mode selection is performed, for example, by evaluating the battery temperature and the outside ambient temperature. In one example, the selection is made based on the ambient temperature, so that if the ambient temperature is above a selected value, the chiller loop is selected, and if it is below another selected value, the HE loop is selected.

If the HE only loop, or HE primary mode 210 is selected, the two solenoids of the duo-valve 150 are opened in step 212, to open both the primary HE and the chiller loop bypass of the coolant. In this exemplary case, the chiller is being used but is not activated as a cooling device. The result of the bypass operation is monitored in step 214, in which the ΔT is compared to a first threshold T1. If it is lower than T1, the HE only is used as the cooling loop so that the chiller loop bypass is closed in step 218, and control returns to step 200. If the ΔT is greater than T1, but less than a fourth threshold T4, as determined in step 216, operation continues through both loops, and control returns to step 214. If ΔT is greater than the fourth threshold T4, the chiller bypass is used exclusively, without any cooling flow passing through the HE, as specified in step 220. This is achieved, for example, by properly configuring the duo valve 150. The result of this mode of operation is evaluated in step 222, to decide whether to continue with the bypass, i.e., with the 100% chiller loop flow. It the ΔT is less than or equal to a third threshold T3, both solenoids are again opened in step 212. Otherwise, control returns to step 214.

If the “chiller only”, or chiller primary operation mode is selected in step 202, the operation is described according to the chiller only loop mode 250. A determination is made in step 252 whether to activate the HE loop bypass, based on evaluating the ambient and battery temperature difference. If the temperature gradient results in more than a specified efficiency threshold, both loops are used, as specified in step 260. Otherwise, if the efficiency is not greater than specified, the bypass is not used, and control returns to step 200.

If the efficiency gain is sufficient, the solenoids for both loops are opened in step 260, thus opening the HE bypass loop and the chiller primary loop. Step 254 determines whether the ΔT is lesser or equal to the first threshold T1. If that is the case, the chiller loop only is selected in step 256, and control returns to step 200.

If the ΔT is greater than T1 but less than or equal to the fourth threshold T4, as determined in step 260, control returns to step 254. This condition is maintained unless the ΔT is greater or equal to T4, in which case the bypass HE loop only is used, as determined in step 261. In step 262 it is determined whether the ΔT has been reduced to less than the third threshold T3, at which time both solenoids are opened to let the coolant flow also through the chiller loop, returning control of the process to step 260. If the ΔT is still greater than T3, control returns to step 254.

If the duplex operation 240 is selected in step 202, both loops are opened in step 246, and the temperature gradient ΔT is compared to the various thresholds T1, T3 and T4 described above. Following step 236, if the ΔT is less than or equal to T1, both loops are opened in step 248. Otherwise, if ΔT is less than T4, control returns to step 236. If ΔT is greater than T1 and also greater than or equal to T4, as determined in step 242, the HE loop only is selected in step 238. This configuration is maintained until step 244 compares the ΔT to T3. If ΔT is less than or equal to T3, control goes to step 246, and both loops are opened. If the ΔT is greater than T3, control returns to step 236.

Those of skill in the art will understand that various values of the thresholds T1, T3, T4, etc. may be selected as appropriate to the cooling system. For example, the thresholds may be a function of the battery installation in the specific vehicle. The efficiencies of the chiller, heat exchanger and other components may affect the thresholds, and so may the properties of the batteries being cooled and of the cooling fluids.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cooling system for a vehicle electric storage device, comprising:
a high flow rate cooling loop in heat transfer communication with the electric storage device, for removing heat therefrom with a coolant;
a first cooling device selectively coupleable to the high flow rate cooling loop, using a refrigerant fluid to transfer heat with the coolant;
a second cooling device selectively coupleable to the high flow rate cooling loop, using ambient air to transfer heat with the coolant;
a valve for directing the coolant to at least a selected one of the first and second cooling devices; and
a controller for implementing a coolant flow bypass function by commanding operation of the valve to bypass the selected one of the cooling devices to limit a temperature gradient between the coolant and the electric storage device.

2. The cooling system according to claim 1, wherein the first cooling device comprises a chiller for transferring heat from the coolant to the refrigerant fluid.

3. The cooling system according to claim 1, wherein the second cooling device comprises a heat exchanger exposed to the ambient air for transferring heat from the coolant.

4. The cooling system according to claim 1, wherein the valve comprises a duo-valve having one of a on/off and a proportional mode of operation to direct the coolant to a desired cooling device.

5. The cooling system according to claim 1, wherein the controller limits the temperature gradient to a gradient beyond which damage to the electric storage device is possible.

7. The cooling system according to claim 1, wherein the controller commands the valve to direct flow of the coolant to a selected one of the first and the second cooling devices, in response to at least one of an ambient temperature and an electric storage device temperature.

8. The cooling system according to claim 1, further comprising a coolant pump for circulating the coolant at a high flow rate sufficient to maintain a homogeneous electric storage device temperature.

9. The cooling system according to claim 7, wherein the controller commands the valve to direct at least a portion of the flow of coolant to bypass the selected one of the first and second cooling devices based on at least one of the temperature gradient and the ambient temperature.

10. The cooling system according to claim 2, wherein the chiller is connected in one of in series and in parallel to an air conditioning system of the vehicle.

11. The cooling system according to claim 1, wherein the controller, when the temperature gradient is less than a selected first threshold, commands the valve to direct substantially all the coolant flow to the selected cooling device.

12. The cooling system according to claim 1, wherein the controller, when the temperature gradient is greater than a selected first threshold, commands the valve to direct the coolant flow to the first and second cooling devices.

13. The cooling system according to claim 12, wherein the controller, when the temperature gradient exceeds a selected fourth threshold, commands the valve to direct substantially all the coolant flow to bypass the selected cooling device.

14. The cooling system according to claim 12, wherein the controller, when the temperature gradient is reduced to below a selected third threshold, commands the valve to direct the coolant flow to the first and second cooling devices.

15. The cooling system according to claim 1, wherein the refrigerant fluid comprises R134 refrigerant.

16. The cooling system according to claim 1, wherein the controller commands directing the coolant flow primarily to a chiller when the ambient temperature is above a selected value, and to a heat exchanger when the ambient temperature is below a further selected value.

17. The cooling system according to claim 2, wherein the controller deactivates the chiller when the second cooling device is selectively coupled.

18. The cooling system according to claim 1, wherein the electric storage device is a battery.

19. A method of cooling a vehicle electric storage device, comprising the acts of:
sensing at least one of an ambient temperature, an electric storage device temperature and a coolant temperature of a coolant for removing heat from the electric storage device;
selecting in a controller, based on the sensed temperatures, one of a refrigerant cooling device and an ambient air cooling device for receiving the coolant and transferring heat with the coolant;
commanding a duo-valve to direct the coolant, as selected by the controller, to maintain a desired temperature gradient between the coolant and the electric storage device; and
based on comparing the temperature gradient to selected thresholds, commanding the duo-valve to direct at least a portion of the coolant to bypass the selected one of the cooling devices and instead flow to the other one of the cooling devices.

20. The method according to claim 19, further comprising initiating the flow bypass when the temperature gradient exceeds a selected first threshold, and terminating the flow bypass when the gradient is reduced below a selected third threshold.

21. The method according to claim 19, further comprising, when the temperature gradient exceeds a selected fourth threshold, commanding the duo valve to direct substantially all the coolant to bypass the selected cooling device.

22. The method according to claim 21, further comprising commanding the duo-valve to direct the coolant to both cooling devices when the temperature gradient is reduced below the selected third threshold.

23. The method according to claim 22, further comprising maintaining the temperature gradient to less than a gradient beyond which damage to the electric storage device may occur.

24. The method according to claim 19, further comprising operating a coolant pump to maintain a high coolant flow rate sufficient to homogeneously cool the electric storage device.

25. The method according to claim 19, further comprising deactivating the refrigerant cooling device when the coolant flow to the ambient air cooling device is bypassed to the refrigerant cooling device.

26. The method according to claim 19, further comprising directing the flow of coolant primarily to the refrigerant cooling device when the ambient temperature is above a selected value.

27. The method according to claim 19, further comprising directing the flow of coolant primarily to an ambient air cooling device when the ambient temperature is below an additional selected value.

28. The method according to claim 19, wherein the electric storage device is a battery.
